(19) United States
(12) Patent Application Publication
(10) Pub. No.: US 2026/0246890 A1
(43) Pub. Date: Aug. 20, 2026

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: SATSUKI ISHIDA, Kanagawa (JP)

(21) Appl. No.: 19/539,141

(22) Filed: Feb. 13, 2026

(30) Foreign Application Priority Data
Feb. 18, 2025 (JP) 2025-024484

(51) Int. Cl. H04N 1/60

(52) U.S. Cl. CPC H04N 1/6058

(57) ABSTRACT

An apparatus comprises a unit configured to set, as a target value, a colorimetric value having a minimum color difference from a first color value among colorimetric values corresponding to a plurality of color values including the first color value and a plurality of second color values generated based on the first color value and a change amount, and, in a case where the target value corresponds to the first color value, update the change amount to a smaller amount based on a difference between the target value and the first color value, and a unit configured to update the change amount to a smaller amount based on a difference between a colorimetric value corresponding to the second color value and the first color value in a case where the target value does not correspond to the first color value.

### BACKGROUND

### Field of the Technology

The present disclosure provides a technique relating to color correction.

### Description of the Related Art

A known image forming apparatus has a spot color printing function for printing a specific color, for example, a desired corporate color with high reproducibility. However, since a desired color cannot be reproduced depending on the hue of the image forming apparatus that prints a spot color and the characteristics of the recording medium, there is a spot color correction function that achieves color reproduction depending on the image forming apparatus and the characteristics of the print medium by colorimetrically measuring a print medium on which the spot color is printed.

For example, Japanese Patent Laid-Open No. 2012-70298 discloses a correction function of printing and colorimetrically measuring 27 color patches in which ΔL and Δab are varied from reference values, selecting a color patch close to a target color from among them, and updating the value as a correction value. However, if the setting values of ΔL and Δab are not appropriate, there is a case where the color of the selected color patch does not match the target color. In that case, the user needs to repeat the work of resetting the color patch with the color of the selected color patch as a new reference color, performing printing and colorimetry, and selecting a color patch close to the target color. There is a problem that manually repeating this work increases the user's work, waste paper, and the ink consumption amount.

Japanese Patent Laid-Open No. 2020-47970 discloses a technique of performing spot color correction without repetition by printing a plurality of color patches arranged at a narrower second color difference interval for each patch in the first 27 color patches.

However, in Japanese Patent Laid-Open No. 2020-47970, since the second color difference interval is uniformly set by ΔE and is not set for each component of L*a*b*, there is a possibility that the selected spot color does not match the target value depending on the image forming apparatus and the characteristics of the print medium. Since 9 patches are further created for each of the 27 patches, there is a problem of a high print amount.

### SUMMARY

The present disclosure provides a technique for more efficiently performing color correction.

According to the first aspect of the present disclosure, there is provided an image processing apparatus comprising: a first update unit configured to set, as a target colorimetric value, a colorimetric value having a minimum color difference from a first color value among colorimetric values corresponding to a plurality of color values including the first color value and a plurality of second color values generated based on the first color value and a change amount, and, in a case where the target colorimetric value corresponds to the first color value, update the change amount to a smaller amount based on a difference between the target colorimetric value and the first color value; and a second update unit configured to update the change amount to a smaller amount based on a difference between a colorimetric value corresponding to the second color value and the first color value in a case where the target colorimetric value does not correspond to the first color value.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating a schematic configuration example of an image forming apparatus.

FIG. 2 is a block diagram illustrating a control configuration example of an image forming apparatus 100.

FIG. 3 is a view illustrating a lattice point group in an Lab color space.

FIG. 4A is a view for describing a spot color correction patch.

FIG. 4B is a view for describing a spot color correction patch.

FIG. 4C is a view for describing a spot color correction patch.

FIG. 5 is a flowchart of processing to be performed by the image forming apparatus 100.

FIG. 6 is a flowchart of processing to be performed by the image forming apparatus 100.

FIG. 7A is a conceptual view illustrating processing in step S613.

FIG. 7B is a conceptual view illustrating processing in step S613.

FIG. 8A is a conceptual view illustrating processing in steps S614 to S617.

FIG. 8B is a conceptual view illustrating processing in steps S614 to S617.

FIG. 9 is a flowchart of processing to be performed by the image forming apparatus 100.

FIG. 10 is a view illustrating a configuration example of an input screen 1000.

FIG. 11 is a flowchart of processing to be performed by the image forming apparatus 100.

FIG. 12 is a view illustrating a configuration example of a screen 1200.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

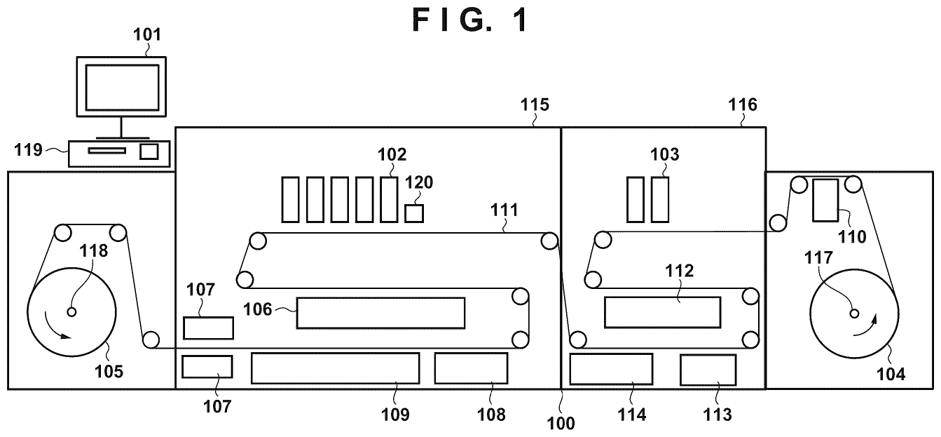

In the present embodiment, a case where the image processing apparatus is applied to an image forming apparatus that performs printing on a print medium will be described. First, a schematic configuration example of an image forming apparatus according to the present embodiment will be described with reference to FIG. 1.

The image forming apparatus 100 illustrated in FIG. 1 is an apparatus that forms an image on roll paper 111, which is a continuous print medium enabling continuous printing. As illustrated in FIG. 1, the image forming apparatus 100 includes a paper feed apparatus 104 that feeds out the roll paper 111, a recording unit 116 that performs spot color printing, a recording unit 115 that performs basic color printing, a take-up apparatus 105 that takes up the roll paper 111, a control PC (print control apparatus) 119 of the image forming apparatus 100, and a user UI (user interface) operation panel 101.

The paper feed apparatus 104 is an apparatus that supplies the roll paper 111 to the image forming apparatus 100. The paper feed apparatus 104 rotates a paper tube of the roll paper 111 about a rotation shaft 117 to convey the roll paper 111 taken up around the paper tube toward the image forming apparatus 100 at a constant speed via a plurality of rollers (conveyance roller, paper feed roller, and the like).

The take-up apparatus 105 is an apparatus that takes up, into a roll shape about the paper tube, the roll paper 111 conveyed from the image forming apparatus 100. The paper tube is attached to a rotation shaft 118, and is rotated about the rotation shaft 118, thereby taking up, as a print product at a predetermined speed, the roll paper 111 conveyed to the paper tube via a plurality of rollers (e.g., conveyance roller and sheet discharge roller). The print product is taken up around the paper tube and held in a roll shape.

As work before print start, the roll paper 111 is passed from the paper feed apparatus 104 to the take-up apparatus 105. More specifically, the roll paper 111 is set in the paper feed apparatus 104, and a leading end of the roll paper 111 is passed over a skew correction apparatus 110 and under an image forming unit 103 of the recording unit 116.

The image forming unit 103 in the present embodiment records (forms) an image on the roll paper 111 using ink of a color (e.g., white ink or the like) other than color ink (cyan (C), magenta (M), yellow (Y), and black (K)).

Then, the roll paper 111 passes under a drying apparatus 112, over cooling apparatuses 113 and 114, under a mark detection sensor 120 and an image forming unit 102 of the recording unit 115, under a drying apparatus 106, and over cooling apparatuses 108 and 109.

In the present embodiment, the mark detection sensor 120 is used for alignment when the image forming unit 102 forms an image on an image formed by the image forming unit 103, but a scanner apparatus may be used, and the present disclosure is not limited to this.

The image forming unit 102 records (forms) an image on the roll paper 111 using color ink (C, M, Y, K ink) as basic printing colors.

Then, the roll paper 111 is wound around the take-up apparatus 105 through a connection scanner apparatus 107. After the roll paper 111 is passed through the image forming apparatus 100, a print job is input to the control PC (print control apparatus) 119 of the image forming apparatus 100. The input method of the print job to the control PC 119 is not limited to a specific method, and for example, the print job may be input to the control PC 119 via a network. Then, after the print job is input to the control PC 119, the user touches a print start button displayed on the UI operation panel 101 with his own finger or the like, thereby instructing the image forming apparatus 100 to perform printing. Upon receiving the print instruction, the image forming apparatus 100 starts an image recording operation on the roll paper 111 based on the input print job.

During the recording of the image on the roll paper 111, the mark detection sensor 120 reads the image printed on the roll paper 111, and the control PC 119 performs analysis on the image read by the mark detection sensor 120 and performs inspection to determine whether there is a failure in the printed matter and causes the UI operation panel 101 to display the inspection result.

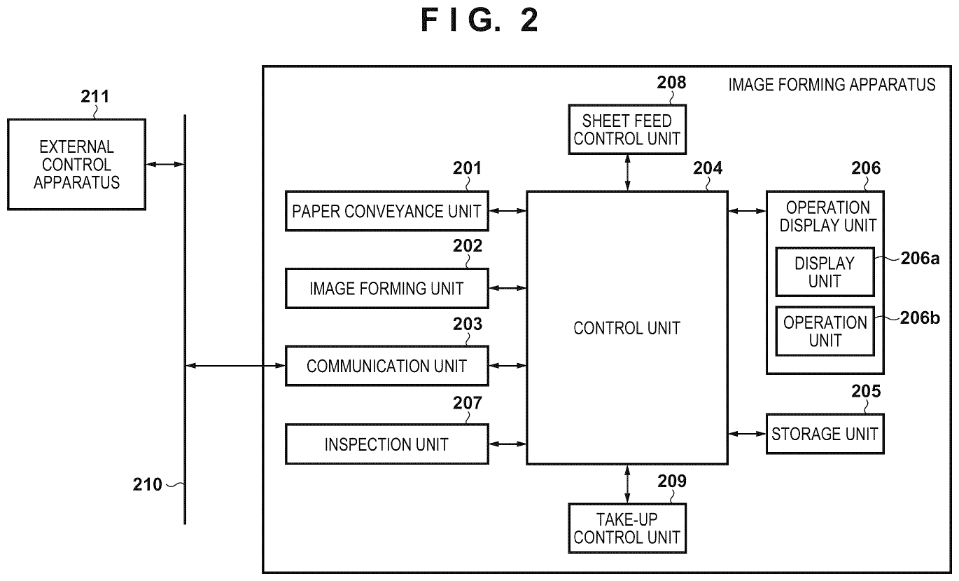

Next, a control configuration example of the image forming apparatus 100 will be described with reference to the block diagram of FIG. 2. FIG. 2 illustrates some of the configurations related to the control in the image forming apparatus 100, and does not illustrate all of the configurations in the image forming apparatus 100.

A paper conveyance unit 201 is a conveyance mechanism for the roll paper 111 inside the image forming apparatus 100. For example, in the paper conveyance unit 201, a plurality of rollers convey, to an image forming unit 202, the roll paper 111 conveyed from a sheet feed control unit 208, and conveys, to a take-up control unit 209, the roll paper 111 having passed through the image forming unit 202.

The sheet feed control unit 208 is a mechanism related to paper feed of the roll paper 111 that can include the paper feed apparatus 104 and the skew correction apparatus 110 of FIG. 1, and the take-up control unit 209 is a mechanism related to take-up of the roll paper 111 that can include the take-up apparatus 105 and the rotation shaft 118 of FIG. 1.

The image forming unit 202 controls the image forming unit 103 and the image forming unit 102 in FIG. 1 based on the print job input to the image forming apparatus 100, and forms an image on the roll paper 111 supplied from the sheet feed control unit 208.

A communication unit 203 is, for example, a communication control card such as a local area network (LAN) card. The communication unit 203 performs transmission and reception of various data to and from an external control apparatus 211 (e.g., a personal computer) connected to a communication network 210 such as a LAN or a wide area network (WAN).

In the external control apparatus 211, a printing application required for printing and the like are installed, and for example, the user can input the above-described print job to the image forming apparatus 100 by operating the external control apparatus 211.

A control unit 204 includes, for example, a processor such as a central processing unit (CPU) and a volatile memory such as a random access memory (RAM).

A CPU of the control unit 204 reads and deploys, into an RAM of the control unit 204, a computer program and data stored in a storage unit 205, and performs various types of processing using the deployed computer program and data. By this, the control unit 204 controls the operation of the entire image forming apparatus 100, and executes or controls various types of processing described as processing to be performed by the image forming apparatus 100. For example, by executing a print job in response to an instruction from the user, the control unit 204 performs various types of control related to recording of an image onto the roll paper 111.

The storage unit 205 is, for example, a nonvolatile memory such as a nonvolatile semiconductor memory (what is called a flash memory) or a hard disk drive (HDD). The storage unit 205 stores various computer programs including a system program and a processing program to be executed by the control unit 204, various data necessary for execution of these computer programs, and the like.

For example, the storage unit 205 stores setting data of the image forming apparatus 100, a computer program and data related to activation of the image forming apparatus 100, a computer program and data related to the basic operation of the image forming apparatus 100, and the like.

An operation display unit 206 performs display of various types of information and reception of operations from the user, and includes a display unit 206a and an operation unit 206b. The display unit 206a is, for example, a liquid crystal display (LCD) with a touch panel, and performs display of various types of information onto a display screen according to a display control signal input from the control unit 204, receives various operations (touch operation and the like) from the user onto the display screen, and notifies the control unit 204 of the content of the received operation as an operation signal. The operation unit 206b has various operation keys such as a numeric keypad and a start key, receives various operation inputs by the user, and notifies the control unit 204 of the content of the received operation as an operation signal.

The operation display unit 206 is used for setting of information related to a print job when executing the print job, for example. For example, using the operation display unit 206, the user can arbitrarily set conditions such as paper to be used, a printing speed, the number of printed sheets, the number of printed copies, a printing length, and a printing diameter.

An inspection unit 207 is an apparatus that performs confirmation of whether an image is successfully printed on the roll paper 111 without discharge failure. For example, by reading a print result of a detection pattern at the time of discharge failure inspection using a reading apparatus such as a scanner, the inspection unit 207 confirms whether there is a discharge failure in a print image, and, in a case of detecting a discharge failure, notifies the control unit 204 of the discharge failure. In a case of receiving a notification that the inspection unit 207 has detected a discharge failure, the control unit 204 stops the operation of the image forming apparatus 100.

Inspection methods include various methods such as a method of printing a detection pattern and reading it with a scanner, a method of directly reading a print image with a camera or a scanner and inspecting it, and a method of monitoring a discharge situation from a nozzle.

Next, an example of an operation for recording an image onto the roll paper 111 in the image forming apparatus 100 will be described. First, the user creates print data using the external control apparatus 211, performs print setting and delivery winding number setting for printing based on the print data, and inputs a print instruction. In response to the input of the print instruction, the external control apparatus 211 transmits, to the image forming apparatus 100 via the communication network 210, a print job including print data (data of an image to be printed) and a job ticket including a print setting and a delivery winding number setting. The control unit 204 of the image forming apparatus 100 receives, via the communication unit 203, the print job transmitted from the external control apparatus 211.

Mechanisms (units) included in the image forming apparatus 100 are controlled by the control unit 204 and other units. In the present embodiment, a state in which the system program is activated but the power supply of hardware parts, which are a mechanisms of the image forming apparatus 100, is off is defined as a “standby state”. In the “standby state”, system control without mechanism operation of the apparatus becomes operable. In the “standby state”, no different from the state in which the apparatus is activated, it is possible to perform apparatus state display by the operation display unit 206 and perform print processing of a print job or other various settings by the control unit 204. In the present embodiment, there are two types of apparatus shutdown methods, “standby state transition” in which only the mechanism part is turned off, and “stop state transition” in which the apparatus is completely turned off The stop state refers to a state in which both hardware and software are off and all various operations are stopped.

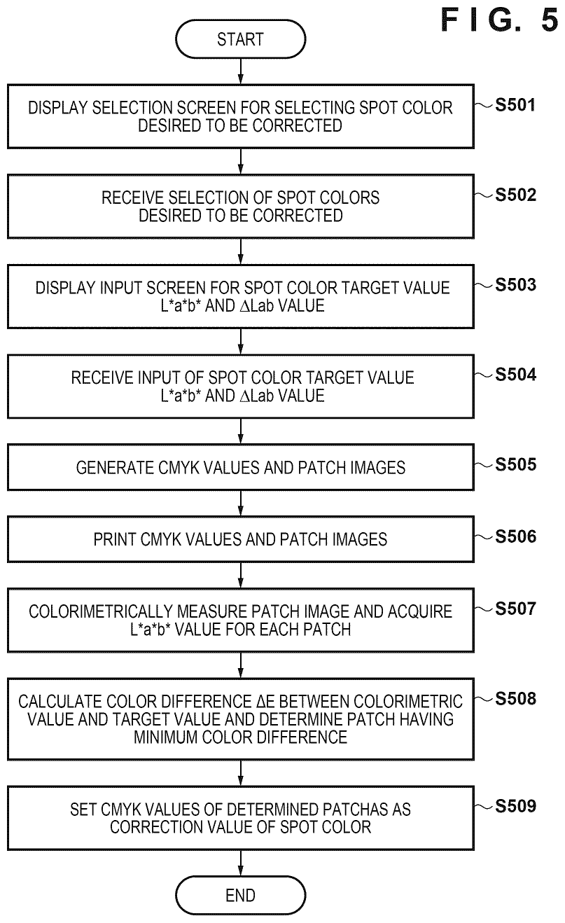

Next, processing to be performed by the image forming apparatus 100 to acquire and store, into the storage unit 205, the correction value of the spot color selected by the user will be described with reference to the flowchart of FIG. 5.

In step S501, the control unit 204 causes the display unit 206a of the operation display unit 206 to display a selection screen for allowing the user to select a spot color desired to be corrected. Using the operation unit 206b of the operation display unit 206, the user operates the selection screen to perform a selection operation for selecting the spot color desired to be corrected.

In step S502, the control unit 204 receives a selection operation performed by the user using the operation unit 206b. The number of spot colors to be selected may be one or more. Hereinafter, a case where one spot color is selected will be described, but in a case where a plurality of spot colors are selected, the subsequent processing may be performed for each spot color.

In step S503, the control unit 204 causes the display unit 206a to display an input screen for allowing the user to input L*, a*, and b* (hereinafter, these may be collectively referred to as L*a*b*), which are target values of the spot color desired to be corrected, and a change amount ΔL of L*, a change amount Δa of a*, and a change amount Δb of b* (hereinafter, these may be collectively referred to as ΔLab).

In step S504, the control unit 204 acquires the target value L*a*b* and ΔLab input by the user using the operation unit 206b. In step S505, using the target value L*a*b* and ΔLab acquired in step S504, the control unit 204 generates color values L*a*b* of a plurality of surrounding colors changed according to ΔLab from the target value L*a*b*.

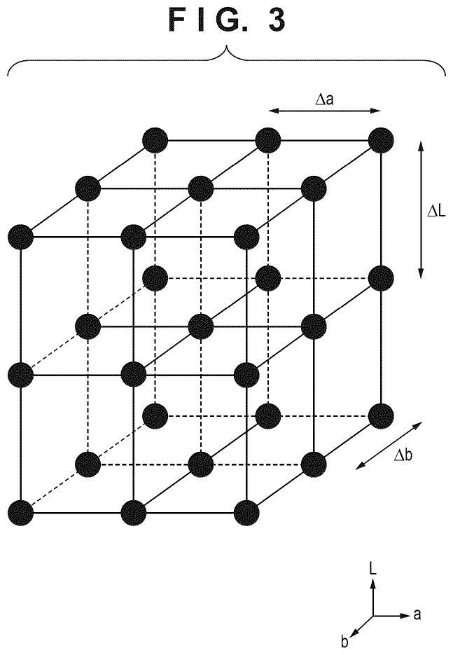

For example, as illustrated in FIG. 3, the control unit 204 obtains, as the color value L*a*b* of a surrounding color, L*a*b* corresponding to 26 lattice points such that the interval between lattice points in an L axis direction is ΔL, the interval between lattice points in an a axis direction is Δa, and the interval between lattice points in a b axis direction is Δb about the lattice point corresponding to the target value L*a*b* in the Lab color space.

Then, the control unit 204 generates “a CMYK value of a printer device-dependent color” and “a patch image that is an image having the CMYK value” for each of a total of 27 colors including the target color and the surrounding 26 colors. The control unit 204 generates the “CMYK value of the printer device-dependent color” using a printer profile of the image forming unit 202.

Then, the control unit 204 generates data (spot color correction patch data) of a spot color correction patch including “the CMYK value of the printer device-dependent color” and “the patch image that is an image having the CMYK value” generated for each of the total of 27 colors including the target color and the surrounding 26 colors.

In step S506, the control unit 204 controls the paper conveyance unit 201 and the image forming unit 202 to print the spot color correction patches based on the spot color correction patch data on the roll paper 111.

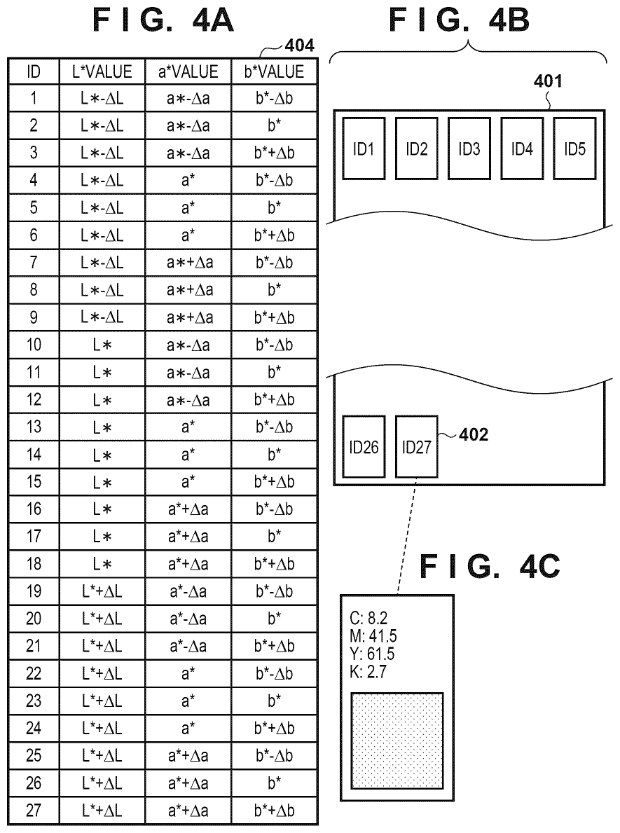

The spot color correction patch will be described with reference to FIG. 4. As shown in Table 404 of FIG. 4A, the control unit 204 manages, for each color of the target color and the surrounding 26 colors, an ID issued to the color and color values L*, a*, b* of the color. In FIG. 4, ID=14 is the ID of the target color (i.e., a color corresponding to the lattice point at the center of the lattice point group in FIG. 3), and hereinafter, the ID of the target color may be referred to as a reference ID. IDs=1 to 13 and 15 to 27 are IDs of the surrounding colors.

As illustrated in FIG. 4B, patch information corresponding to each of the IDs=1 to 27 is printed on a spot color correction patch 401 printed on the roll paper 111. As illustrated in FIG. 4C, the patch information includes CMYK values corresponding to the patch information and a patch image corresponding to the patch information.

In step S507, the control unit 204 controls the inspection unit 207 and colorimetrically measures the patch image corresponding to each of the IDs=1 to 27 printed on the roll paper 111 to acquire the colorimetric value L*a*b* of the patch image.

In step S508, for i=1 to 27, the control unit 204 obtains a color difference ΔE_i between the colorimetric value L*a*b* of the patch image corresponding to ID=i and the target value L*a*b*, and specifies a minimum color difference ΔE_M among the color differences ΔE_1 to ΔE_27.

In step S509, the control unit 204 stores the CMYK value corresponding to ID=M into the storage unit 205 as the correction value of the spot color selected by the user as the spot color desired to be corrected.

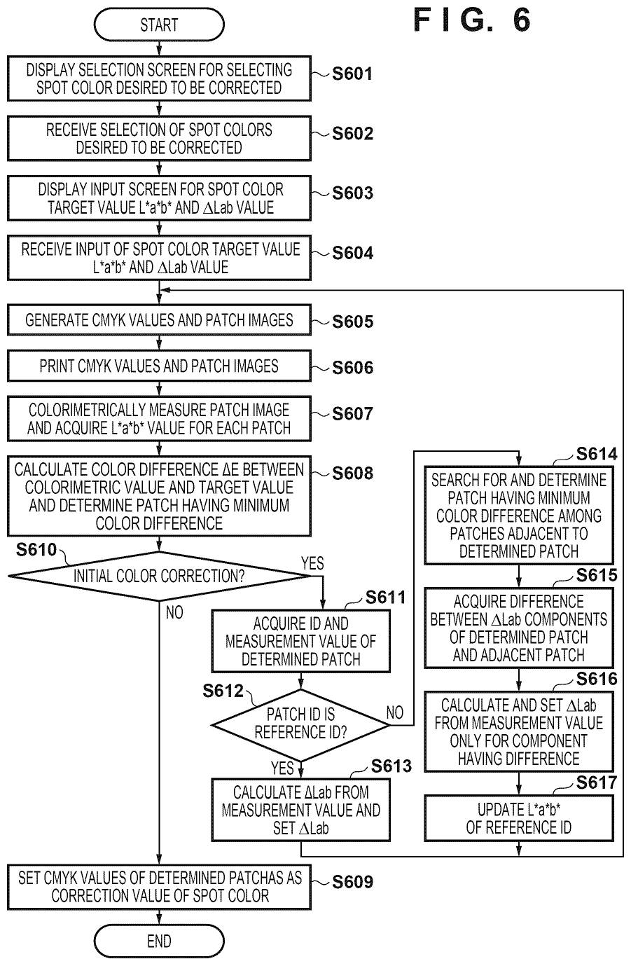

Next, processing to be performed by the image forming apparatus 100 for updating the ΔLab after the processing in steps S501 to S509 described above is performed will be described with reference to the flowchart of FIG. 6. Note that the processing in each of steps S601 to S609 is similar to the processing in steps S501 to S509 described above, and thus the description of these steps will be omitted.

In step S610, the control unit 204 determines whether it is the initial color correction (i.e., whether it is the initial ΔLab correction). As a result of this determination, in a case where it is the initial correction, the processing proceeds to step S611, and in a case where it is not the initial correction, the processing proceeds to step S609.

In step S609, processing similar to that in step S509 described above is performed, but in a case where the correction value of the spot color obtained last time is stored in the storage unit 205, the control unit 204 updates the correction value of the spot color obtained last time to the correction value of the spot color obtained this time.

In step S611, the control unit 204 acquires ID=M, which is an ID corresponding to the minimum color difference ΔE_M, and the colorimetric value (target colorimetric value) L*a*b* of the patch image corresponding to ID=M.

In step S612, the control unit 204 determines whether or not ID=M is the reference ID (here, ID=14). As a result of this determination, in a case where ID=M is the reference ID, the processing proceeds to step S613, and in a case where ID=M is not the reference ID, the processing proceeds to step S614.

In step S613, the control unit 204 updates ΔL to ΔL′, which decreases as the difference between the colorimetric value L* of the patch image corresponding to ID=M and the target value L* decreases. Similarly, the control unit 204 updates Δa to Δa′, which decreases as the difference between the colorimetric value a* of the patch image corresponding to ID=M and the target value a* decreases. Similarly, the control unit 204 updates Δb to Δb′, which decreases as the difference between the colorimetric value b* of the patch image corresponding to ID=M and the target value b* decreases. Then, the processing proceeds to step S605, and the processing in and after step S605 is executed using the updated ΔLab.

In step S614, the control unit 204 searches for and specifies L*a*b* having the minimum color difference obtained in step S608 from L*a*b* adjacent to the color value L*a*b* corresponding to ID=M in the Lab color space among the color values L*a*b* of the 27 colors described above. For example, in the lattice point group of FIG. 3, the control unit 204 searches for a lattice point having the minimum color difference obtained in step S608 among lattice points adjacent to the lattice point corresponding to ID=M, and specifies L*a*b* corresponding to the lattice point found by the search.

In step S615, the control unit 204 specifies, as the target component, a component in which a difference between components corresponding to the color values L*, a*, and b* corresponding to ID=M and the color values L*, a*, and b* found in the search in step S614 is non-0.

For example, it is assumed that L*a*b* of ID=26 is found in the search in step S614. At this time, the difference between L* corresponding to ID=14 and L* corresponding to ID=26 is non-0. The difference between a* corresponding to ID=14 and a* corresponding to ID=26 is non-0. The difference between b* corresponding to ID=14 and b* corresponding to ID=26 is 0. Therefore, in this case, the control unit 204 specifies L* and a* as target components.

In step S616, the control unit 204 calculates a difference ΔEP only for the target component between the measurement value L*a*b* of the surrounding color (IDs=1 to 13 and 15 to 27) and the target value L*a*b*, and updates the change amount of the target component among ΔL, Δa, and Δb of the surrounding color to a change amount that decreases as ΔEP calculated for the target component decreases.

For example, it is assumed that L*a*b* of ID=23 is found in the search in step S614. At this time, the target component is L*. Therefore, the control unit 204 calculates a difference ΔEP between the measurement value L* of the surrounding color and the target value L*, and updates the change amount of ΔL of the surrounding color to ΔL′, which decreases as the ΔEP decreases.

Note that the processing in step S615 described above may be omitted, and in step S616, the control unit 204 may update ΔL to ΔL′, which decreases as the difference between the colorimetric value L* of the surrounding color and the target value L* decreases, update Δa to Δa′, which decreases as the difference between the colorimetric value a* of the surrounding color and the target value a* decreases, and update Δb to Δb′, which decreases as the difference between the colorimetric value b* of the surrounding color and the target value b* decreases.

In step S617, the control unit 204 updates the target value L*a*b* corresponding to the reference ID to the color value L*a*b* of the surrounding color corresponding to ID=M. Then, the processing proceeds to step S605, and the processing in and after step S605 is executed using the updated ΔLab and the target value L*a*b*.

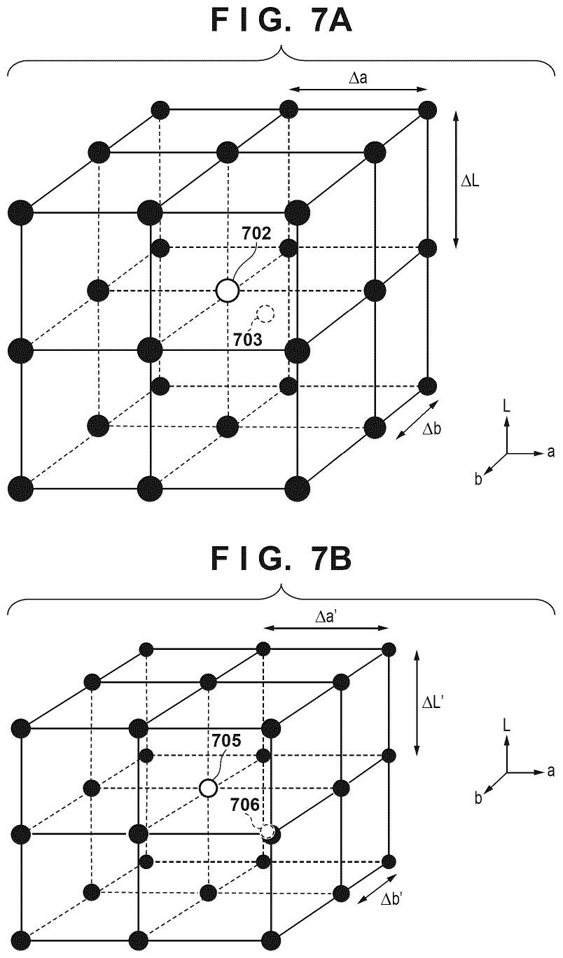

Next, the processing in step S613 described above will be described with reference to the conceptual view of FIG. 7. FIG. 7A illustrates, as lattice points corresponding to the surrounding colors, 26 lattice points such that the interval between lattice points in the L axis direction is ΔL, the interval between lattice points in the a axis direction is Δa, and the interval between lattice points in the b axis direction is Δb about a lattice point 702 corresponding to a target value Ltatbt in the Lab color space. FIG. 7 illustrates the lattice points in a case where the same values are set to ΔL, Δa, and Ab, but different values may be set to ΔL, Δa, and Ab.

A lattice point 703 is a lattice point corresponding to a colorimetric value L0a0b0 of a patch image corresponding to the reference ID. In FIG. 7, the “lattice point corresponding to the colorimetric value L0a0b0 of the patch image corresponding to the reference ID” is explicitly described in the lattice point group, but it is actually unclear where in the lattice point group a “lattice point corresponding to the colorimetric value Ltatbt of the patch image corresponding to the reference ID” exists.

In step S613, the control unit 204 obtains ΔL′ by performing calculation according to the following Equation (1) based on the difference between a target value Lt and a measurement value L0. The control unit 204 obtains Δa′ by performing calculation according to the following Equation (1) based on the difference between a target value at and a measurement value a0. The control unit 204 obtains Δb′ by performing calculation according to the following Equation (1) based on the difference between a target value bt and a measurement value b0.

$${Δ L}^{′} = \sqrt{{( {L}_{t} - {L}_{0} )}^{2}} \qquad ( 1 )$$

$${Δ a}^{′} = \sqrt{{( {a}_{t} - {a}_{0} )}^{2}}$$

$${Δ b}^{′} = \sqrt{{( {b}_{t} - {b}_{0} )}^{2}}$$

ΔL′, Δa′, and Δb′ are values smaller than ΔL, Δa, and Ab, respectively, and values that decrease as the differences between the target values and the measurement values of the corresponding color components decrease. Here, in a case where any of ΔL′, Δa′, and Δb′ is 0, L*a*b* corresponding to one ID is the same as L*a*b* of the other ID from the above table 404, but in this case, patch images corresponding to IDs having overlapping L*a*b* values need not be printed.

The lattice point group arranged based on ΔL, Δa, and Δb updated to ΔL′, Δa′, and Δb′, respectively, is illustrated in FIG. 7B. FIG. 7B illustrates, as lattice points corresponding to the surrounding colors, 26 lattice points such that the interval between lattice points in the L axis direction is ΔL (=ΔL′), the interval between lattice points in the a axis direction is Δa (=Δa′), and the interval between lattice points in the b axis direction is Δb (=Δb′) about a lattice point 705 corresponding to a target value Ltatbt in the Lab color space. The lattice point 705 is the same lattice point as the lattice point 702, and a lattice point 706 is the same lattice point as the lattice point 703.

Since updating ΔL, Δa, and Δb to smaller ΔL′, Δa′, and Δb′, respectively, corresponds to a change amount of each color component, the color difference between the measurement value of any of the surrounding colors and the target value is reduced, and the spot color can be corrected with high accuracy.

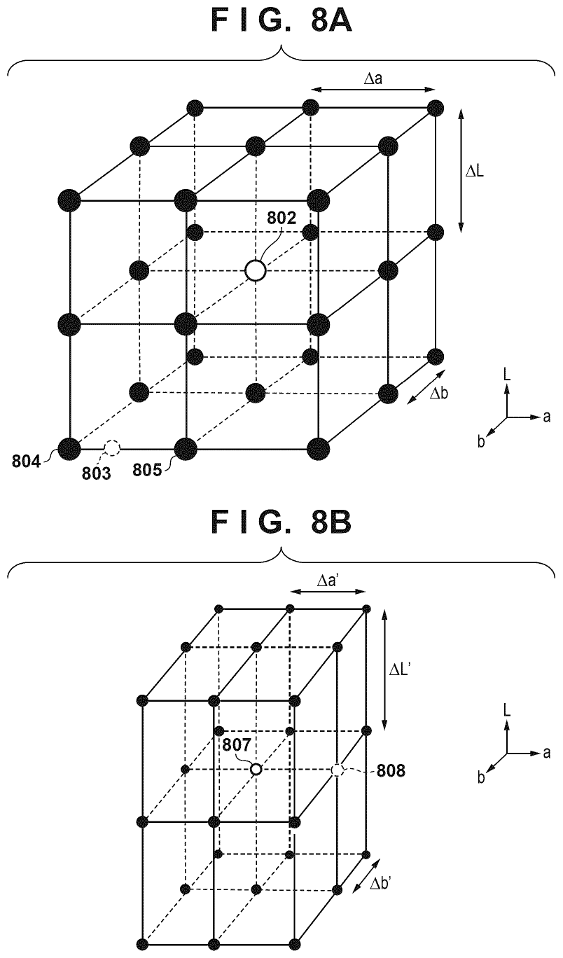

Next, the processing in steps S614 to S617 described above will be described with reference to the conceptual view of FIG. 8. FIG. 8A illustrates, as lattice points corresponding to the surrounding colors, 26 lattice points such that the interval between lattice points in the L axis direction is ΔL, the interval between lattice points in the a axis direction is Δa, and the interval between lattice points in the b axis direction is Δb about a lattice point 802 corresponding to the target value Ltatbt in the Lab color space. Here, the measurement value L*a*b* corresponding to the lattice point of the surrounding color corresponding to ID=i (i=1 to 13 and 15 to 27) is represented as Liaibi. FIG. 8 illustrates the lattice points in a case where the same values are set to ΔL, Δa, and Δb, but different values may be set to ΔL, Δa, and Δb.

A lattice point 803 is a lattice point corresponding to a colorimetric value L0a0b0 of a patch image corresponding to the reference ID. In FIG. 8, the “lattice point corresponding to the colorimetric value L0a0b0 of the patch image corresponding to the reference ID” is explicitly described in the lattice point group, but it is actually unclear where in the lattice point group a “lattice point corresponding to the colorimetric value Ltatbt of the patch image corresponding to the reference ID” exists. A lattice point 804 is a lattice point corresponding to ID=M. Hereinafter, as an example, assume M=1 and the colorimetric value corresponding to the lattice point 804 is L1a1b1.

In step S614, the control unit 204 searches for a lattice point having the minimum color difference obtained in step S608 among lattice points adjacent to the lattice point 804, and specifies L*a*b* corresponding to the lattice point found by the search. It is assumed that the lattice point found by this search is a lattice point 805, and the ID corresponding to the lattice point 805 is “4”.

In step S615, the control unit 204 specifies, as the target component, a component in which a difference between components corresponding to L*, a*, and b* corresponding to ID=1 and L*, a*, and b* corresponding to ID=4 is non-0. In the example of FIG. 4, the control unit 204 specifies a* as the target component.

In step S616, in a case where L* is the target component, the control unit 204 obtains ΔL′ by performing calculation according to the following Equation (2) based on the difference between a measurement value Li of the surrounding color (ID=i=1 to 13 and 15 to 27) and a target value Lt. In a case where a* is the target component, the control unit 204 obtains Δa′ by performing calculation according to the following Equation (2) based on the difference between a measurement value ai of the surrounding color (ID=i=1 to 13 and 15 to 27) and a target value at. In a case where b* is the target component, the control unit 204 obtains Δb′ by performing calculation according to the following Equation (2) based on the difference between a measurement value bi of the surrounding color (ID=i=1 to 13 and 15 to 27) and a target value bt.

$${Δ L}^{′} = \sqrt{{( {L}_{t} - {L}_{0} )}^{2}} \qquad ( 2 )$$

$${Δ a}^{′} = \sqrt{{( {a}_{t} - {a}_{0} )}^{2}}$$

$${Δ b}^{′} = \sqrt{{( {b}_{t} - {b}_{0} )}^{2}}$$

ΔL′, Δa′, and Δb′ are values smaller than ΔL, Δa, and Δb, respectively, and values that decrease as the differences between the measurement values and the target values decrease. The lattice point group arranged based on ΔL, Δa, and Δb updated to ΔL′, Δa′, and Δb′, respectively, is illustrated in FIG. 8B. FIG. 8B illustrates, as lattice points corresponding to the surrounding colors, 26 lattice points such that the interval between lattice points in the L axis direction is ΔL (=ΔL′), the interval between lattice points in the a axis direction is Δa (=Δa′), and the interval between lattice points in the b axis direction is Δb (=Δb′) about a lattice point 807 corresponding to ID=M in the Lab color space. The lattice point 807 is the same lattice point as the lattice point 802, and a lattice point 808 is the same lattice point as the lattice point 803.

Since updating one or more of ΔL, Δa, and Δb to smaller amounts as described above corresponds to a change amount of each color component, the color difference between the measurement value of any of the surrounding colors and the target value is reduced, and the spot color can be corrected with high accuracy. That is, according to the present embodiment, highly accurate spot color correction can be achieved with a small print amount.

### Second Embodiment

In each of the following embodiments including the present embodiment, only the difference from the first embodiment will be described, assuming that they are similar to the first embodiment unless otherwise stated. In the present embodiment, before the initial spot color correction, an input screen of the target value L*a*b*, ΔLab, and a color difference threshold ΔE′ that are to be corrected is displayed on the display unit 206a. The user inputs these pieces of information to the image forming apparatus 100 using the operation unit 206b. Then, in a case where the minimum color difference ΔE_M exceeds ΔE′, the control unit 204 executes re-correction of the spot color again.

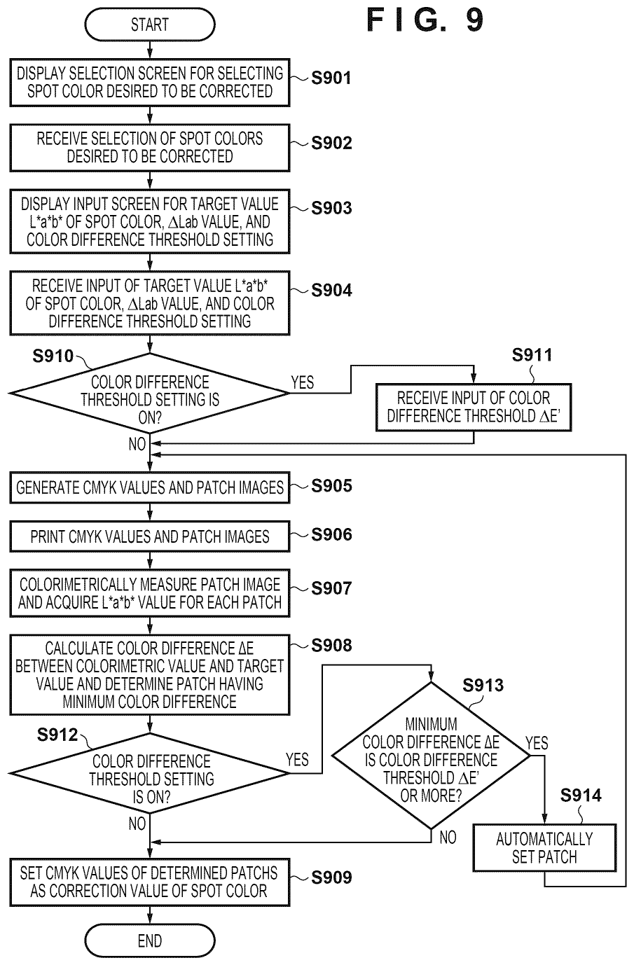

Processing to be performed by the image forming apparatus 100 to acquire and store, into the storage unit 205, the correction value of the spot color selected by the user will be described with reference to the flowchart of FIG. 9. In FIG. 9, the processing in each of step S901, step S902, and steps S905 to S909 is similar to the processing in step S501, step S502, and steps S505 to S509 described above, and thus the description related to these steps will be omitted. Step S914 is a step in which steps S611 to S617 described above are combined, and since these steps are as described above, the description related to step S914 will also be omitted.

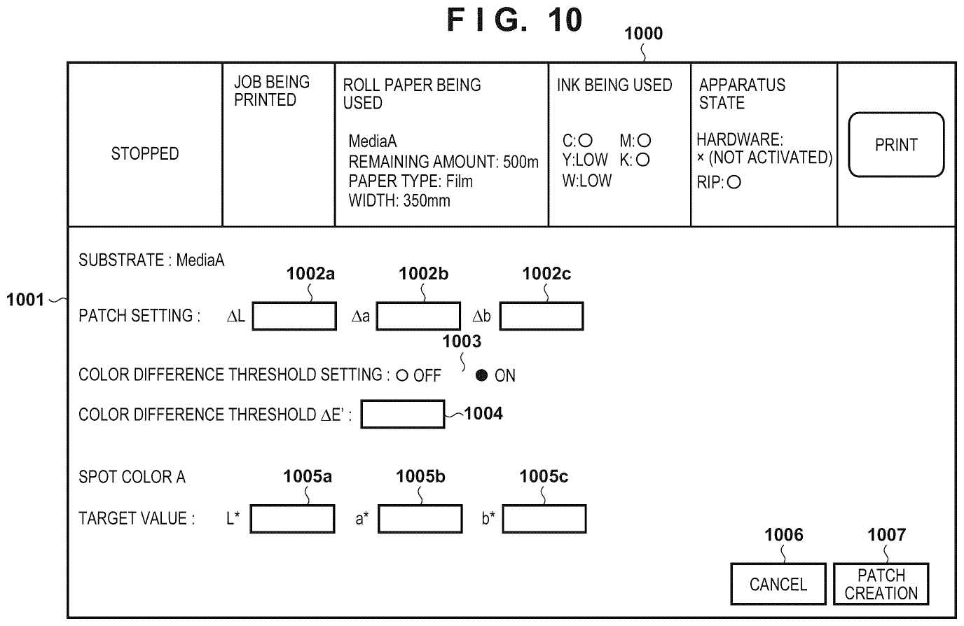

In step S903, the control unit 204 causes the display unit 206a to display the input screen 1000 exemplified in FIG. 10. A box 1002a is an input area for inputting ΔL, a box 1002b is an input area for inputting Δa, and a box 1002c is an input area for inputting Δb.

A button 1003 is a button for switching on/off of the color difference threshold setting. When “off” at the button 1003 is instructed, the color difference threshold setting is set to off, and when “on” at the button 1003 is instructed, the color difference threshold setting is set to on.

A box 1004 becomes enabled (a state in which numerical value input is possible) in a case where the color difference threshold setting is set to on, and becomes disabled (a state in which numerical value input is impossible) in a case where the color difference threshold setting is set to off In a case where the color difference threshold setting is set to on, the color difference threshold ΔE′ can be input in the box 1004.

A box 1005a is an input area for inputting the target value L*, a box 1005b is an input area for inputting the target value a*, and a box 1005c is an input area for inputting the target value b*.

Using the operation unit 206b, the user can input ΔL, Δa, and Δb to the boxes 1002a to 1002c, respectively, can set the color difference threshold setting to on/off by operating the button 1003, and can input the target values L*, a*, and b* to the boxes 1005a to 1005c, respectively.

In step S904, the control unit 204 receives input to the boxes 1002a to 1002c, input to the button 1003, and input to the boxes 1005a to 1005c.

Then, in step S910, the control unit 204 determines whether or not the user has set the color difference threshold setting to on by operating the button 1003. As a result of such determination, in a case where the user has set the color difference threshold setting to on by operating the button 1003, the processing proceeds to step S911. On the other hand, in a case where the user has set the color difference threshold setting to off by operating the button 1003, the processing proceeds to step S905.

In step S911, the control unit 204 enables the box 1004 (a state in which numerical value input is possible) and receives input to the box 1004. Then, when the user makes an instruction on a button 1007 using the operation unit 206b, the processing proceeds to step S905.

Note that on the input screen 1000, when the user makes an instruction on a button 1006 using the operation unit 206b, the control unit 204 discards the content input on the input screen 1000, hides the input screen 1000 on the display unit 206a, and ends the processing according to the flowchart of FIG. 9.

In step S912, similarly to step S910 described above, the control unit 204 determines whether or not the user has set the color difference threshold setting to on by operating the button 1003. As a result of such determination, in a case where the user has set the color difference threshold setting to on by operating the button 1003, the processing proceeds to step S913. On the other hand, in a case where the user has set the color difference threshold setting to off by operating the button 1003, the processing proceeds to step S909.

In step S913, the control unit 204 determines whether or not the minimum color difference ΔE_M specified in step S608 described above is ΔE′ or more. As a result of such determination, in a case where the minimum color difference ΔE_M specified in step S608 described above is ΔE′ or more, the processing proceeds to step S914. On the other hand, in a case where the minimum color difference ΔE_M specified in step S608 described above is less than ΔE′, the processing proceeds to step S909.

Note that in the present embodiment, the case where the input screen 1000 is displayed on the display unit 206a has been described, but the input screen 1000 may be displayed on the UI operation panel 101. In this case, the user operates a user interface (keyboard, mouse, touch panel screen, or the like) of the control PC 119 to input ΔLab, ΔE′, and the target value L*a*b* on the input screen 1000. When the user makes an instruction on the button 1007 by operating the user interface of the control PC 119, the processing in and after step S910 is performed.

### Third Embodiment

In the present embodiment, in a case where the minimum color difference ΔE_M exceeds ΔE′, an inquiry is made to the user as to whether or not to execute re-correction of the spot color, and in a case where a user operation to perform the re-correction of the spot color is performed, the re-correction of the spot color is performed.

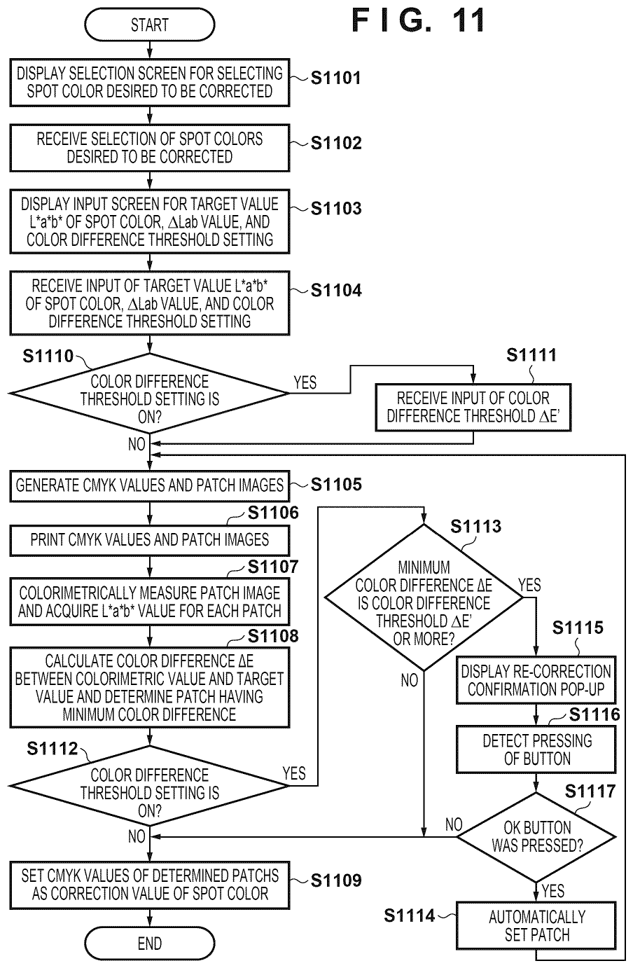

Processing to be performed by the image forming apparatus 100 to acquire and store, into the storage unit 205, the correction value of the spot color selected by the user will be described with reference to the flowchart of FIG. 11. In FIG. 11, the processing in each of steps S1101 to S1114 is similar to the processing in steps S901 to S914 described above, and thus the description related to these steps will be omitted.

In the determination processing in step S1113, in a case where the minimum color difference ΔE_M specified in step S608 described above is ΔE′ or more, the processing proceeds to step S1115. On the other hand, in a case where the minimum color difference ΔE_M specified in step S608 described above is less than ΔE′, the processing proceeds to step S1109.

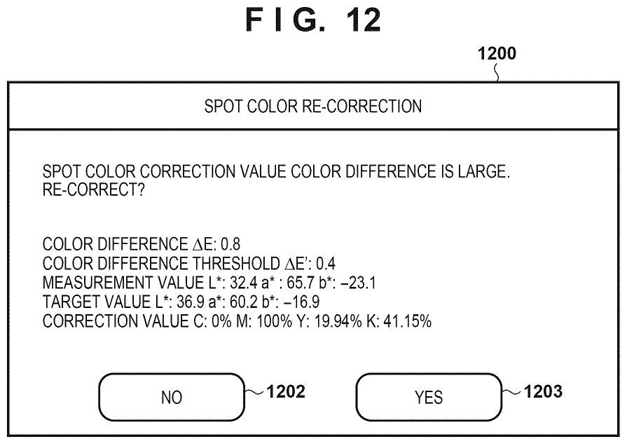

In step S1115, the control unit 204 causes the display unit 206a to display the screen 1200 for making an inquiry to the user as to whether or not to perform re-correction of the spot color illustrated in FIG. 12. The screen 1200 displays a message for making an inquiry to the user as to whether or not to perform re-correction of the spot color. The screen 1200 displays the minimum color difference ΔE_M as the color difference ΔE, displays ΔE′ input to the box 1004 described above as the color difference threshold ΔE′, and displays the colorimetric value L*a*b* of the patch image corresponding to ID=M as the measurement value. The screen 1200 displays L*a*b* input to the boxes 1005a to 1005c described above as the target value, and displays the CMYK value corresponding to ID=M as the correction value.

In step S1116, the control unit 204 receives a user operation on a button 1202 and a button 1203. In step S1117, the control unit 204 determines whether the user has made an instruction on the button 1202 or the button 1203 (OK button) using the operation unit 206b. As a result of such determination, in a case where the user makes an instruction on the button 1202 using the operation unit 206b, the processing proceeds to step S1109. On the other hand, in a case where the user makes an instruction on the button 1203 (OK button) using the operation unit 206b, the processing proceeds to step S1114.

### Fourth Embodiment

In the embodiments described above, cases where the processing according to the flowchart is performed by the image forming apparatus 100 have been described, but part of the processing according to the flowchart may be executed by a control PC 119 or the external control apparatus 211. In such a case, the image processing apparatus may be an apparatus including the control PC 119 and the external control apparatus 211 in addition to the image forming apparatus 100.

The various screens used in the embodiments described above are examples, and for example, the configurations of the screens, the display content of the screens, the operation methods of the screens, the apparatuses for displaying the screens, and the like are examples, and are not limited to the above description.

In the embodiments described above, the colorimetric target is a patch image, but the colorimetric target is not limited to a patch image as long as a colorimetric value can be obtained by colorimetry. For example, the colorimetric target may be characters of different colors or marks of different colors.

That is, the image processing apparatus sets, as a target colorimetric value, a colorimetric value having a minimum color difference from a first color value among colorimetric values corresponding to a plurality of color values including the first color value and a plurality of second color values generated based on the first color value and a change amount, and, in a case where the target colorimetric value corresponds to the first color value, updates the change amount to a smaller amount based on a difference between the target colorimetric value and the first color value, and updates the change amount to a smaller amount based on a difference between a colorimetric value corresponding to the second color value and the first color value in a case where the target colorimetric value does not correspond to the first color value.

Numerical values, processing timings, processing orders, processing subjects, data (information) configurations/acquisition methods/transmission destinations/transmission sources/storage locations, and the like used in the embodiments described above are given as examples for giving specific descriptions, and are not intended to be limited to such examples.

Alternatively, some or all of the embodiments described above may be appropriately combined and used. Alternatively, some or all of the embodiments described above may be selectively used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-024484, filed Feb. 18, 2025, which is hereby incorporated by reference herein in its entirety.

What is claimed is:

1. An image processing apparatus comprising:
a first update unit configured to set, as a target colorimetric value, a colorimetric value having a minimum color difference from a first color value among colorimetric values corresponding to a plurality of color values including the first color value and a plurality of second color values generated based on the first color value and a change amount, and, in a case where the target colorimetric value corresponds to the first color value, update the change amount to a smaller amount based on a difference between the target colorimetric value and the first color value; and
a second update unit configured to update the change amount to a smaller amount based on a difference between a colorimetric value corresponding to the second color value and the first color value in a case where the target colorimetric value does not correspond to the first color value.

2. The image processing apparatus according to claim 1, wherein the second update unit searches for a second color value having a minimum color difference from the first color value among second color values adjacent to a second color value corresponding to the target colorimetric value, specifies a color component having a difference between the second color value found by the search and the second color value corresponding to the target colorimetric value, and updates the change amount to be smaller as a difference between a value of the color component and a measurement value of the color component of the second color value is smaller at the first color value.

3. The image processing apparatus according to claim 1, further comprising a unit configured to store a CMYK value corresponding to the target colorimetric value into a memory as a correction value of a color to be corrected.

4. The image processing apparatus according to claim 1, wherein the first color value is a color value input in response to a user operation as a target value of a color to be corrected.

5. The image processing apparatus according to claim 1, wherein the change amount is a change amount input in response to a user operation.

6. The image processing apparatus according to claim 1, wherein in a case where a color difference between the target colorimetric value and the first color value exceeds a threshold, processing by the first update unit and the second update unit is repeated.

7. The image processing apparatus according to claim 1 further comprising
a unit configured to inquire of a user whether or not to repeat processing by the first update unit and the second update unit in a case where a color difference between the target colorimetric value and the first color value exceeds a threshold, wherein
when a user operation to repeat the processing by the first update unit and the second update unit is performed, the processing by the first update unit and the second update unit is repeated.

8. The image processing apparatus according to claim 6, wherein the threshold is a threshold input in response to a user operation.

9. An image processing method to be performed by an image processing apparatus, the image processing method comprising:
setting, as a target colorimetric value, a colorimetric value having a minimum color difference from a first color value among colorimetric values corresponding to a plurality of color values including the first color value and a plurality of second color values generated based on the first color value and a change amount, and, in a case where the target colorimetric value corresponds to the first color value, updating the change amount to a smaller amount based on a difference between the target colorimetric value and the first color value; and
updating the change amount to a smaller amount based on a difference between a colorimetric value corresponding to the second color value and the first color value in a case where the target colorimetric value does not correspond to the first color value.

10. A non-transitory computer-readable storage medium storing a computer program for causing a computer to function as
a first update unit configured to set, as a target colorimetric value, a colorimetric value having a minimum color difference from a first color value among colorimetric values corresponding to a plurality of color values including the first color value and a plurality of second color values generated based on the first color value and a change amount, and, in a case where the target colorimetric value corresponds to the first color value, update the change amount to a smaller amount based on a difference between the target colorimetric value and the first color value; and
a second update unit configured to update the change amount to a smaller amount based on a difference between a colorimetric value corresponding to the second color value and the first color value in a case where the target colorimetric value does not correspond to the first color value.
